(19) United States
(12) Patent Application Publication
(10) Pub. No.: US 2023/0334916 A1
(43) Pub. Date: Oct. 19, 2023

(54) TASK MANAGEMENT DEVICE, SYSTEM, VEHICLE, AND TASK MANAGEMENT METHOD

(71) Applicant: TOYOTA JIDOSHA KABUSHIKI KAISHA, Toyota-shi (JP)

(72) Inventors: Hirotaka NOGAMI, Nisshin-shi (JP); Jun Tsukamoto, Seto-shi (JP); Tsuyoshi Okada, Nagoya-shi (JP); Fumiyuki Kagara, Sagamihara-shi (JP); Kotaro Hirose, Nisshin-shi (JP); Yoshiki Terashima, Okazaki-shi (JP); Yohei Ando, Okazaki-shi (JP)

(73) Assignee: TOYOTA JIDOSHA KABUSHIKI KAISHA, Toyota-shi (JP)

(21) Appl. No.: 18/122,809

(22) Filed: Mar. 17, 2023

(30) Foreign Application Priority Data
Apr. 18, 2022 (JP) 2022-068419

(51) Int. Cl. G07C 5/00; B60W 50/04

(52) U.S. Cl. CPC G07C 5/008; G07C 5/006; B60W 50/04; B60W 2050/0095

(57) ABSTRACT

The task management device includes a control unit that performs maintenance start control for starting maintenance of the internal environment of the vehicle during a period in which the vehicle operated in the mode corresponding to the application is operated in the first mode, and performs mode switching control for switching the vehicle to the second mode different from the first mode after the maintenance is completed.

### CROSS-REFERENCE TO RELATED APPLICATION

This application claims priority to Japanese Patent Application No. 2022-068419 filed on Apr. 18, 2022, incorporated herein by reference in its entirety.

### BACKGROUND

### 1. Technical Field

The present disclosure relates to a task management device, a system, a vehicle, and a task management method.

### 2. Description of Related Art

Japanese Unexamined Patent Application Publication No. 2020-170456 (JP 2020-170456 A) discloses a system for managing vehicles that can be used for a plurality of applications.

### SUMMARY

When the application of the vehicle is switched, such as a change from a mobile shop vehicle or a delivery vehicle to a bus, it takes time to perform maintenance on an internal environment, such as cleaning of the inside of the vehicle. As a result, it is conceivable that the switching of the application of the vehicle is delayed.

The present disclosure provides a technique for speeding up switching of applications of a vehicle.

A task management device according to the present disclosure includes a control unit configured to: execute maintenance start control for starting maintenance of an internal environment of a vehicle during a period in which the vehicle operated in a mode corresponding to an application is operated in a first mode; and execute mode switching control for switching the vehicle to a second mode different from the first mode after the maintenance is completed.

A task management method according to the present disclosure includes: executing maintenance start control for starting maintenance of an internal environment of a vehicle by a control unit during a period in which the vehicle operated in a mode corresponding to an application is operated in a first mode; and executing mode switching control for switching the vehicle to a second mode different from the first mode by the control unit after the maintenance is completed.

According to the present disclosure, the application of the vehicle can be quickly switched.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a configuration of a system according to an embodiment of the present disclosure;

FIG. 2 is a block diagram illustrating a configuration of a task management device according to an embodiment of the present disclosure;

FIG. 3 is a flowchart illustrating an operation of a task management device according to an embodiment of the present disclosure;

FIG. 4 is a flow chart showing a specific sequence of the process of step S1 of FIG. 3; and

FIG. 5 is a flow chart illustrating a modification of the specific process of the step S1 of FIG. 3.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

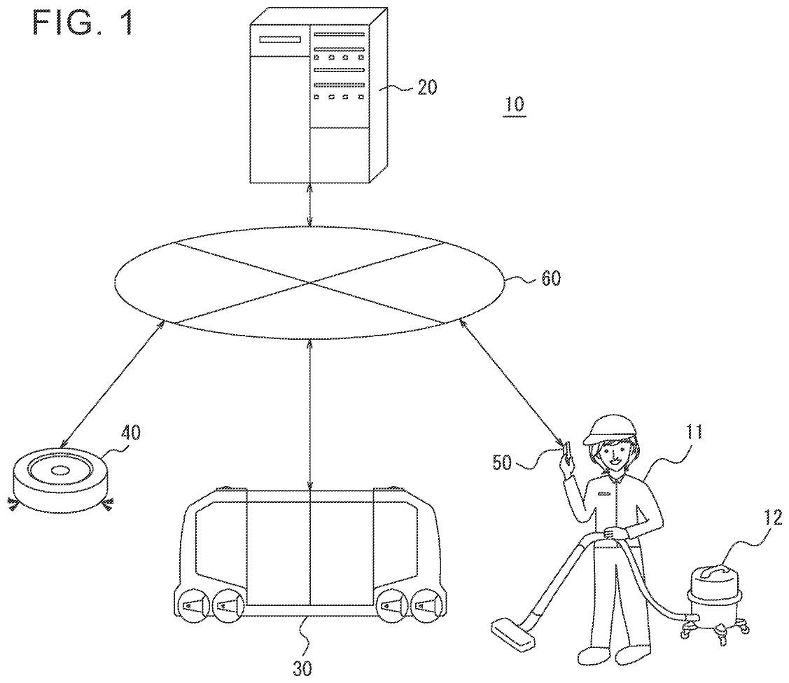

The configuration of a system 10 according to the present embodiment will be described with reference to FIG. 1.

The system 10 according to the present embodiment includes at least one task management device 20, at least one vehicle 30, at least one robot 40, and at least one terminal device 50. The task management device 20 can communicate with the vehicle 30, the robot 40, and the terminal device 50 via the network 60.

The task management device 20 is installed in a facility such as a data center. The task management device 20 is operated by a business operator who manages the vehicle 30. The task management device 20 is a computer such as a server belonging to a cloud computing system or another computing system.

The vehicle 30 is operated in a mode corresponding to an application such as delivery of an article, transportation of a passenger, or sale of an article. The mode of the vehicle 30 is switched by changing the interior and/or exterior. The vehicle 30 is, for example, a mounted vehicle capable of freely removing or moving a rear seat or installing a table without using a tool by using a dedicated floor structure utilizing a plurality of rails. Vehicle 30 is equipped with a display such as a LCD or an organic EL, for example, as part of an exterior. By switching the content displayed on the display, the vehicle 30 can freely change the exterior of the vehicle 30. LCD is an abbreviation for liquid crystal display. “EL” is an abbreviation for electro luminescent. The vehicle 30 may be utilized as an on-demand bus. The vehicle 30 may be equipped with a power source, lighting, a table, a monitor, or any combination thereof, and may be used as an opportunity space or an office at a destination. The vehicle 30 may be utilized for other purposes, such as sales of goods, delivery of goods, or provision of administrative services. By changing the interior and/or exterior of the vehicle 30, it is also possible to selectively use the vehicle 30 according to the day of the week or the time zone.

The vehicle 30 is a vehicle of any type, such as a gasoline vehicle, a diesel vehicle, a hydrogen vehicle, an HEV, a PHEV, a BEV, or an FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The vehicles 30 are AV in the present embodiment. However, the vehicle 30 may be driven by a driver. Alternatively, the driving of the vehicle 30 may be automated at any level. AV stands for autonomous vehicle. The level of autonomous driving is, for example, one of levels 1 to 5 in the SAE leveling, for example. “SAE” is an abbreviation for Society of Automotive Engineers. The vehicle 30 may be a MaaS dedicated vehicle. MaaS is an abbreviation for Mobility as a Service.

The robot 40 stands by at a base on or near a route on which the vehicle 30 moves. The robot 40 has a function of performing maintenance of the internal environment of the vehicle 30. The robot 40 is, for example, a robot cleaner.

The terminal device 50 is held by the worker 11 and used by the worker 11. The terminal device 50 is, for example, a mobile device such as a mobile phone, a smartphone, or a tablet. The worker 11 may wait on the route on which the vehicle 30 moves or at a base near the route. In the present embodiment, the worker 11 is an occupant of the vehicle 30. The worker 11 performs maintenance of the internal environment of the vehicle 30 using the equipment 12. The equipment 12 is, for example, a vacuum cleaner.

Network 60 includes the Internet, at least one WAN, at least one MAN, or any combination thereof. WAN is an abbreviation for wide area network. MAN is an abbreviation for metropolitan area network. Network 60 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

During the period P1 in which the vehicles 30 are operated in the first mode M1, the task management device 20 performs maintenance start control C1. The maintenance start control C1 is a control for starting the maintenance of the interior of the vehicles 30. Maintenance includes, for example, cleaning, odor removal or disinfection, or temperature adjustment. The task management device 20 performs mode switching control C2 after the maintenance is completed. The mode switching control C2 is a control for switching the vehicles 30 to the second mode M2 that differs from the first mode M1.

The application corresponding to the first mode M1 may be any application. The application corresponding to the first mode M1 is, in the present embodiment, sales of goods or delivery of goods. The application corresponding to the second mode M2 may be any application as long as it is different from the application corresponding to the first mode M1. The application corresponding to the second mode M2 is in this embodiment the transportation of passengers.

In the present embodiment, the environment inside the vehicle 30 can be maintained by the time when the use of the vehicle 30 is switched, such as a change from a mobile shop vehicle or a delivery vehicle to a bus. Therefore, according to the present embodiment, the use of the vehicle 30 can be quickly switched. That is, the mode can be switched quickly.

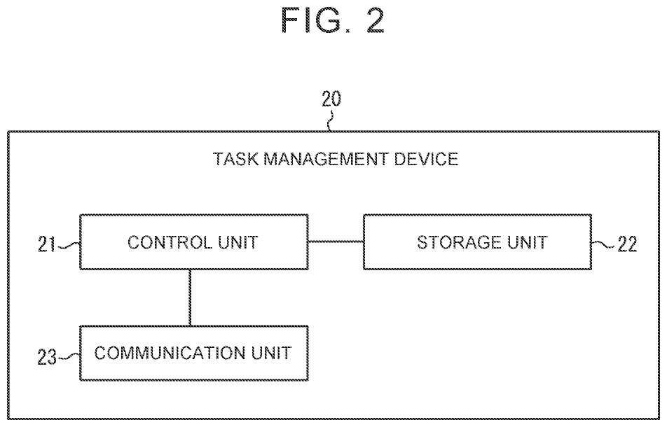

A configuration of the task management device 20 according to the present embodiment will be described with reference to FIG. 2.

The task management device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processing related to the operation of the task management device 20 while controlling each unit of the task management device 20.

The storage unit 22 includes at least one semiconductor memory, at least one magnetic memory, at least one optical memory, or any combination thereof. The semiconductor memory is, for example, a RAM, ROM or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The flash memory is, for example, a SSD. “SSD” is an abbreviation for solid-state drive. The magnetic memories are, for example, HDD. “HDD” is an abbreviation for hard disk drive. The storage unit 22 functions as, for example, a main storage device, an auxiliary storage device, or a cache memory. The storage unit 22 stores data used for the operation of the task management device 20 and data obtained by the operation of the task management device 20.

The communication unit 23 includes at least one communication interface. The communication interface is, for example, an interface compliant with a wired LAN communication standard such as Ethernet (registered trademark), or an interface compliant with a wired LAN communication standard such as IEEE802.11. “IEEE” is an abbreviation for Institute of Electrical and Electronics Engineers. The communication unit 23 communicates with the vehicle 30, the robot 40, and the terminal device 50. The communication unit 23 receives data used for the operation of the task management device 20 and transmits data obtained by the operation of the task management device 20.

The function of the task management device 20 is realized by executing the program according to the present embodiment by a processor serving as the control unit 21. That is, the function of the task management device 20 is realized by software. The program causes the computer to function as the task management device 20 by causing the computer to execute the operation of the task management device 20. That is, the computer functions as the task management device 20 by executing the operation of the task management device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The server stores the program in the storage. The program may be distributed by transferring the program from the server to another computer. The program may be provided as a program product.

The computer temporarily stores the program stored in the portable medium or the program transferred from the server in the main storage device, for example. Then, the computer reads the program stored in the main storage device by the processor. The computer executes processing in accordance with the read program on the processor. The computer may read the program directly from the portable medium and execute processes in accordance with the program. Each time a program is transferred from a server to a computer, the computer may sequentially execute processing according to the received program. The program is not transferred from the server to the computer. The process may be executed by a so-called ASP type service which realizes the function only by the execution instruction and the result-acquisition. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

Some or all of the functions of the task management device 20 may be realized by a programmable circuit or a dedicated circuit as the control unit 21. That is, some or all of the functions of the task management device 20 may be realized by hardware.

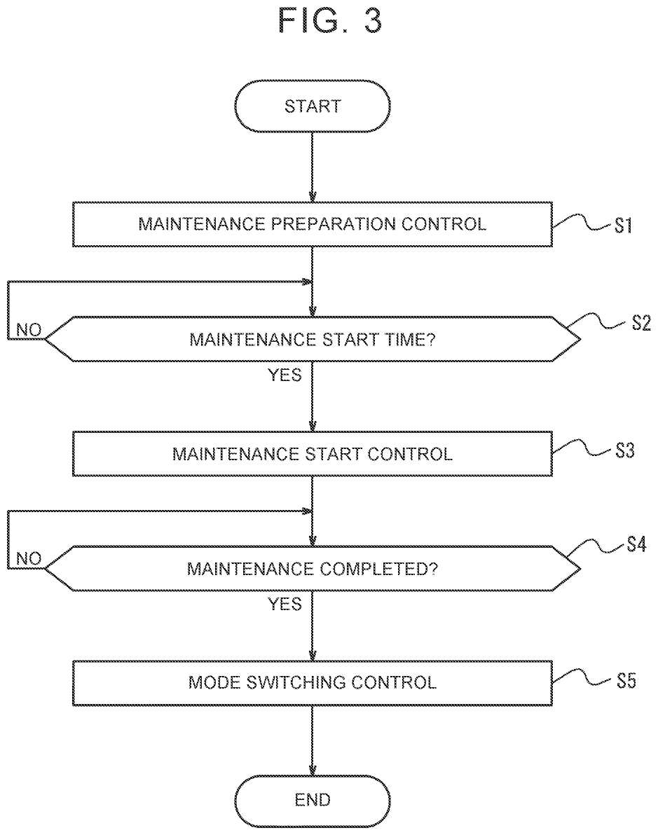

The operation of the task management device 20 according to the present embodiment will be described with reference to FIG. 3. This operation corresponds to the task management method according to the present embodiment.

In S1 of steps, the control unit 21 of the task management device 20 performs maintenance-preparation control C0. The maintenance preparation control C0 is a control for performing preparation for maintenance of the interior of the vehicles 30.

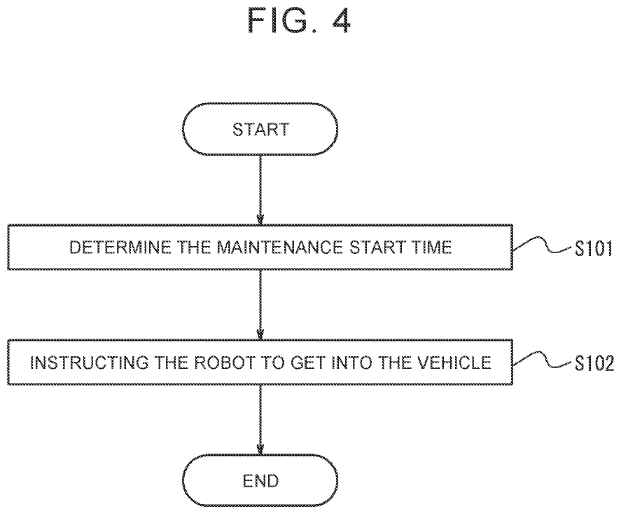

A specific process of the step S1 is shown in FIG. 4.

In the step S101, the control unit 21 of the task management device 20 determines the maintenance start time Tx prior to the vehicle 30 being operated in the first mode M1 or during the period P1 in which the vehicle 30 is being operated in the first mode M1. The maintenance start time Tx is the start time of maintenance during the period P1.

More specifically, the control unit 21 of the task management device 20 acquires the start time data Dt1 indicating the start time of the period P2 in which the vehicle 30 is operated in the second mode M2 and the required time data Dt2 indicating the required time for maintenance from the storage unit 22 of the task management device 20 or an external storage. For example, it is assumed that the vehicle 30 is operated as a mobile shop vehicle or a delivery vehicle from now on, or is now in operation, and is subsequently operated as a bus. Here, the start time data Dt1 is data indicating the start time of the operation of the vehicles 30 as busses. The required time data Dt2 includes, for example, data indicating a time taken by the robot 40 to clean the inside of the vehicle 30. The required time data Dt2 may include data indicating a time taken for the air-purifier installed in the vehicle 30 to remove an odor inside the vehicle 30 or to sterilize the inside of the vehicle 30. The required time data Dt2 may include data indicating a time taken for the air conditioner installed in the vehicle 30 to adjust the temperature inside the vehicle 30. The control unit 21 determines the maintenance start time Tx by referring to the acquired start time data Dt1 and required time data Dt2. As a method of determining the maintenance start time Tx, any method may be used, but for example, a method of obtaining, as the maintenance start time Tx, a value obtained by subtracting the time indicated by the required time data Dt1 from the time indicated by the required time data Dt2 may be used. A certain grace time may be further subtracted from the time indicated by the start time-data Dt1. The time from the time indicated by the start time data Dt1 to the time indicated by the start time data Dt1 may be further subtracted from the time required for the mode-switching of the step S5.

In S102 of steps, the control unit 21 of the task management device 20 transmits the first instruction-data Di1 to the robot 40 via the communication unit 23. The first instruction Di1 instructs the robot 40 to get into the vehicle 30 during the period P1 in which the vehicle 30 is operating in the first mode M1. The robot 40 receives the first instruction Di1 from the task management device 20 via a communication unit corresponding to a mobile communication standard such as LTE, 4G standard or 5G standard or a wired LAN communication standard such as IEEE802.11 of the robot 40. The term “LTE” is an abbreviation for “long term evolution”. The term “4G” is an abbreviation for “fourth generation”. The term “5G” is an abbreviation for “fifth generation”. The robots 40 autonomously move into the vehicles 30 in accordance with the received first instruction-data Di1. The robot 40 may get into the vehicle 30 when the vehicle 30 is stopped, or may get into the vehicle 30 when the vehicle 30 is moving.

The control unit 21 of the task management device 20 determines a point at which the robot 40 gets into the vehicle 30 based on information such as a position, a speed, or a route acquired from the vehicle 30 by the task management device 20 and information such as a position acquired from the robot 40 by the task management device 20. Alternatively, the vehicle 30 may determine a point at which the robot 40 rides on the vehicle 30 based on information, such as the location directly by the vehicle 30 or acquired from the robot 40 via the task management device 20. Alternatively, the robot 40 may determine a point at which the robot 40 gets into the vehicle 30 based on information such as a position, a speed, or a route acquired from the vehicle 30 by the robot 40 directly or via the task management device 20. When the point at which the robot 40 gets into the vehicle 30 is determined by the task management device 20 or the vehicle 30, data indicating the point may be transmitted from the task management device 20 to the robot 40 as part of the first instruction data Di1. When the information from the vehicles 30 is acquired by the robot 40 via the task management device 20, the information may be transmitted from the task management device 20 to the robot 40 as part of the first instruction-data Di1.

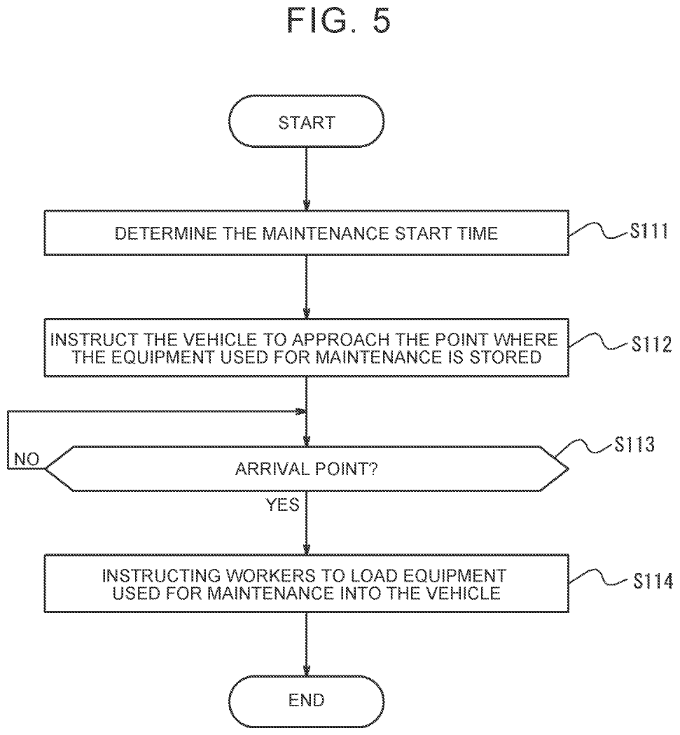

FIG. 5 shows a modification of the process of the step-wise S1.

In step S111, similarly to step S101, the control unit 21 of the task management device 20 acquires the start time data Dt1 indicating the start time of the period P2 in which the vehicle 30 is operated in the second mode M2 and the required time data Dt2 indicating the required time for maintenance from the storage unit 22 of the task management device 20 or an external storage. The required time data Dt2 includes, for example, data indicating the time taken for the worker 11 to clean the inside of the vehicle 30. The required time data Dt2 may include data indicating a time taken for the air-purifier installed in the vehicle 30 to remove an odor inside the vehicle 30 or to sterilize the inside of the vehicle 30. The required time data Dt2 may include data indicating a time taken for the air conditioner installed in the vehicle 30 to adjust the temperature inside the vehicle 30. Similarly to the step S101, the control unit 21 refers to the acquired start time data Dt1 and required time data Dt2 to determine the maintenance start time Tx.

In the step S112, the control unit 21 of the task management device 20 transmits the second instruction-data Di2 to the vehicle 30 via the communication unit 23 during the period P1 in which the vehicle 30 is operated in the first mode M1. The second instruction Di2 instructs the vehicles 30 to approach the point where the equipment 12 is stored. The vehicle 30 receives the second instruction-data Di2 from the task management device 20 via a communication unit corresponding to a mobile communication standard such as LTE, 4G standard or 5G standard or a wired LAN communication standard such as IEEE802.11 of the vehicle 30. Vehicle 30 autonomously moves in accordance with the received second instruction-data Di2 to a point where equipment 12 is stored.

The point at which the vehicle 30 comes may be designated in advance, may be determined by the control unit 21 of the task management device 20, or may be determined by the vehicle 30. When a point where the vehicle 30 is located is designated in advance or is determined by the task management device 20, the task management device 20 may transmit data indicating the point to the vehicle 30 as a part of the second instruction data Di2.

In S113 of steps, the control unit 21 of the task management device 20 waits until the vehicle 30 arrives at the point where the equipment 12 is stored. Whether or not the vehicle 30 has arrived is determined by the control unit 21 of the task management device 20 based on information such as a position acquired from the vehicle 30 by the task management device 20 and map information stored in advance in the storage unit 22 of the task management device 20 or an external storage. When the vehicles 30 arrive at the point where the equipment 12 is stored, the process of the step S114 is executed.

In the step S114, the control unit 21 of the task management device 20 transmits the third instruction-data Di3 to the terminal device 50 via the communication unit 23 during the period P1 in which the vehicle 30 is operated in the first mode M1. The third instruction Di3 instructs the worker 11 to load the equipment 12 used for maintenance into the vehicles 30. The terminal device 50 receives the third instruction Di3 from the task management device 20 via a communication unit corresponding to a mobile communication standard such as LTE, 4G standard or 5G standard or a wired LAN communication standard such as IEEE802.11 of the terminal device 50. The terminal device 50 displays the received third instruction Di3 on a display of the terminal device 50, such as a LCD or an organic EL. Alternatively, the terminal device 50 may output the received third instruction-data Di3 from the speaker of the terminal device 50 by sound. The worker 11 loads the equipment 12 onto the vehicles 30 in accordance with the third instruction-data Di3 displayed or audibly outputted.

In S2 of steps, the control unit 21 of the task management device 20 waits until the maintenance-start time Tx is reached. When the maintenance start time Tx is reached, the process of step S3 is executed.

In S3 of steps, the control unit 21 of the task management device 20 performs maintenance start control C1 during the period P1 in which the vehicles 30 are operated in the first mode M1. The maintenance start control C1 is a control for starting the maintenance of the interior of the vehicles 30.

Specifically, the control unit 21 of the task management device 20 performs maintenance starting control C1 by transmitting the fourth instruction-data Di4 to the robot 40 via the communication unit 23 as a result of the process of the step S102. The fourth instruction Di4 instructs the robot 40 to start maintenance after the robot 40 gets into the vehicle 30. The robot 40 receives the fourth instruction Di4 from the task management device 20 via the communication unit of the robot 40. The robot 40 starts maintenance in accordance with the received fourth instruction-data Di4. For example, the robot 40 cleans the inside of the vehicle 30 while autonomously moving.

When the vehicle 30 has a function of automatically performing maintenance, the control unit 21 of the task management device 20 may perform maintenance starting control C1 by transmitting the fifth instruction data Di5 to the vehicle 30 via the communication unit 23 instead of or in addition to transmitting the fourth instruction data Di4 to the robot 40. The fifth instruction Di5 instructs the vehicles 30 to begin maintenance. In such a modification, the vehicle 30 receives the fifth instruction-data Di5 from the task management device 20 via the communication unit of the vehicle 30. The vehicle 30 starts maintenance in accordance with the received fifth instruction-data Di5. For example, the vehicle 30 uses an air cleaner installed in the vehicle 30 to remove an odor inside the vehicle 30 or to sterilize the inside of the vehicle 30. Alternatively, the vehicle 30 may adjust the temperature inside the vehicle 30 using the air conditioner installed in the vehicle 30.

When the modification shown in FIG. 5 is applied to the process of step S1, the control unit 21 of the task management device 20 performs maintenance starting control C1 by transmitting the sixth instruction data Di6 to the terminal device 50 via the communication unit 23 as a result of the process of step S112 to step S114. The sixth instruction Di6 instructs the worker 11 to begin maintenance after the worker 11 loads the equipment 12 into the vehicle 30 at the point where the equipment 12 is stored. The terminal device 50 receives the sixth instruction data Di6 from the task management device 20 via the communication unit of the terminal device 50. The terminal device 50 displays the received sixth instruction Di6 on the display of the terminal device 50. Alternatively, the terminal device 50 may output the received sixth instruction Di6 from the speaker of the terminal device 50 by sound. The worker 11 starts maintenance in accordance with the sixth instruction-data Di6 displayed or audibly outputted. For example, the worker 11 cleans the inside of the vehicle 30 using the equipment 12 such as a vacuum cleaner. Alternatively, the worker 11 may use an air cleaner installed in the vehicle 30 to remove an odor inside the vehicle 30 or to sterilize the inside of the vehicle 30. Alternatively, the worker 11 may adjust the temperature inside the vehicle 30 using the air conditioner installed in the vehicle 30.

In the step-wise S4, the control unit 21 of the task management device 20 waits until the maintenance of the interior of the vehicle 30 is completed. Whether or not maintenance is completed is determined by the control unit 21 of the task management device 20 based on information such as an internal image acquired from the vehicle 30 by the task management device 20 or information related to the progress of maintenance acquired from the robot 40 or the terminal device 50 by the task management device 20. When the maintenance is completed, the process of the step S5 is executed.

In S5 of steps, the control unit 21 of the task management device 20 performs mode switching control C2. The mode switching control C2 is a control for switching the vehicles 30 to the second mode M2 that differs from the first mode M1.

Specifically, the control unit 21 of the task management device 20 performs the mode switching control C2 by transmitting the seventh instruction-data Di7 to the terminal device 50 via the communication unit 23 after the maintenance is completed. The seventh instruction Di7 instructs the worker 11 to change the interior or exterior of the vehicle 30 to the interior or exterior corresponding to the second mode M2. The terminal device 50 receives the seventh instruction data Di7 from the task management device 20 via the communication unit of the terminal device 50. The terminal device 50 displays the received seventh instruction Di7 on the display of the terminal device 50. Alternatively, the terminal device 50 may output the received seventh instruction-data Di7 from the speaker of the terminal device 50 by sound. The worker 11 changes the interior or exterior of the vehicle 30 in accordance with the seventh instruction-data Di7 displayed or audibly outputted. For example, the worker 11 attaches a rear seat for passengers of the bus to sit or moves the rear seat to a specific position. Alternatively, the worker 11 displays the operation information such as the destination of the bus on a display provided by the vehicle 30 as a part of the exterior.

When the vehicle 30 has a function of automatically changing the interior or exterior of the vehicle 30, the control unit 21 of the task management device 20 may perform the mode switching control C2 by transmitting, to the vehicle 30 via the communication unit 23, the eighth instruction data Di8 instructing the vehicle 30 to change the interior or exterior of the vehicle 30 to the interior or exterior corresponding to the second mode M2, instead of or in addition to transmitting the seventh instruction data Di7 to the terminal device 50. In such a modification, the vehicle 30 receives the eighth instruction-data Di8 from the task management device 20 via the communication unit of the vehicle 30. The vehicle 30 changes the interior or exterior of the vehicle 30 in accordance with the received eighth instruction-data Di8. For example, the vehicle 30 moves the rear seat for the passenger of the bus to a specific position. Alternatively, the vehicle 30 displays the operation information such as the destination of the bus on a display provided by the vehicle 30 as a part of the exterior.

As described above, in the present embodiment, the robot 40 or the equipment 12 is picked up during the traveling plan of the mobile sales or the delivery plan of the logistics, and maintenance such as cleaning is performed while the plan is advanced at the end, whereby the use of the vehicle 30 can be quickly switched to the bus. According to the example in which the robot 40 is picked up, cost reduction is also possible.

As a modification of the present embodiment, the task management device may be provided in the vehicle 30.

Some of the embodiments of the present disclosure are exemplified below. It should be noted, however, that embodiments of the present disclosure are not limited thereto.

### APPENDIX 1

A task management device includes a control unit. The control unit executes maintenance start control for starting maintenance of an internal environment of a vehicle during a period in which the vehicle operated in a mode corresponding to an application is operated in a first mode, and executes mode switching control for switching the vehicle to a second mode different from the first mode after the maintenance is completed.

### APPENDIX 2

The task management device according to Appendix 1 further includes a communication unit that performs communication with a robot that performs the maintenance, and the control unit transmits data instructing the robot to get into the vehicle to the robot via the communication unit during the period.

### APPENDIX 3

In the task management device according to Appendix 2, the control unit executes the maintenance start control by transmitting, to the robot via the communication unit, data instructing the robot to start the maintenance after the robot gets into the vehicle.

### APPENDIX 4

A system includes: the task management device according to Appendix 2 or 3; and the robot.

### APPENDIX 5

The task management device according to Appendix 1 further includes a communication unit that performs communication with a terminal device of a worker who performs the maintenance, and the control unit transmits, to the terminal device via the communication unit, data instructing the worker to load equipment used for the maintenance into the vehicle during the period.

### APPENDIX 6

In the task management device according to Appendix 5, the communication unit also performs communication with the vehicle, and the control unit transmits, to the vehicle via the communication unit, data instructing the vehicle to drop by a point where the equipment is stored during the period.

### APPENDIX 7

In the task management device according to Appendix 6, the control unit executes the maintenance start control by transmitting, to the terminal device via the communication unit, data instructing the worker to start the maintenance after the worker loads the equipment to the vehicle at the point.

### APPENDIX 8

A system includes: the task management device according to any one of Appendices 5 to 7; and the terminal device.

### APPENDIX 9

The task management device according to Appendix 1 further includes a communication unit that communicates with the vehicle. The vehicle automatically performs the maintenance. The control unit performs the maintenance start control by transmitting data instructing the vehicle to start the maintenance to the vehicle via the communication unit.

### APPENDIX 10

A system includes: the task management device according to Appendix 9; and the vehicle.

### APPENDIX 11

The task management device according to Appendix 1 further includes a communication unit that performs communication with a terminal device of a worker who changes an interior or an exterior of the vehicle. The control unit executes the mode switching control by transmitting data instructing the worker to change the interior or the exterior of the vehicle to the interior or the exterior corresponding to the second mode to the terminal device via the communication unit.

### APPENDIX 12

The task management device according to Appendix 1 further includes a communication unit that communicates with the vehicle. The vehicle automatically changes an interior or an exterior of the vehicle. The control unit executes the mode switching control by transmitting, to the vehicle via the communication unit, data instructing the vehicle to change the interior or the exterior of the vehicle to the interior or the exterior corresponding to the second mode.

### APPENDIX 13

In the task management device according to any one of Appendices 1 to 3, 5 to 7, 9, and 11 and 12, the control unit determines a start time of the maintenance during the period by referring to data indicating a start time of a period in which the vehicle is operated in the second mode and data indicating a required time of the maintenance.

### APPENDIX 14

In the task management device according to any one of Appendices 1 to 3, 5 to 7, 9, and 11 and 13, an application corresponding to the first mode is sales of a product or delivery of an article, and an application corresponding to the second mode is transportation of a passenger.

### APPENDIX 15

In the task management device according to any one of Appendices 1 to 3, 5 to 7, 9, and 11 to 14, the maintenance includes cleaning.

### APPENDIX 16

In the task management device according to any one of appendices 1 to 3, 5 to 7, 9, and 11 to 15, the maintenance includes odor removal or sterilization.

### APPENDIX 17

In the task management device according to any one of Appendices 1 to 3, 5 to 7, 9, and 11 to 16, the maintenance includes temperature adjustment.

### APPENDIX 18

A vehicle includes the task management device according to any one of Appendices 1 to 3, 5, 11 and 13 to 16.

### APPENDIX 19

A task management method includes: executing maintenance start control for starting maintenance of an internal environment of a vehicle by a control unit during a period in which the vehicle operated in a mode corresponding to an application is operated in a first mode; and executing mode switching control for switching the vehicle to a second mode different from the first mode by the control unit after the maintenance is completed.

### APPENDIX 20

The task management method according to Appendix 19 further includes instructing a robot that performs the maintenance to get into the vehicle during the period.

The present disclosure is not limited to the embodiments described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A task management device comprising a control unit configured to:
execute maintenance start control for starting maintenance of an internal environment of a vehicle during a period in which the vehicle operated in a mode corresponding to an application is operated in a first mode; and
execute mode switching control for switching the vehicle to a second mode different from the first mode after the maintenance is completed.

2. The task management device according to claim 1, further comprising a communication unit configured to perform communication with a robot that performs the maintenance, wherein the control unit is configured to transmit data instructing the robot to get into the vehicle to the robot via the communication unit during the period.

3. The task management device according to claim 2, wherein the control unit is configured to execute the maintenance start control by transmitting, to the robot via the communication unit, data instructing the robot to start the maintenance after the robot gets into the vehicle.

4. A system comprising:
the task management device according to claim 2; and
the robot.

5. The task management device according to claim 1, further comprising a communication unit configured to perform communication with a terminal device of a worker who performs the maintenance, wherein the control unit is configured to transmit, to the terminal device via the communication unit, data instructing the worker to load equipment used for the maintenance into the vehicle during the period.

6. The task management device according to claim 5, wherein:
the communication unit is configured to communicate with the vehicle; and
the control unit is configured to transmit, to the vehicle via the communication unit, data instructing the vehicle to drop by a point where the equipment is stored during the period.

7. The task management device according to claim 6, wherein the control unit is configured to execute the maintenance start control by transmitting, to the terminal device via the communication unit, data instructing the worker to start the maintenance after the worker loads the equipment to the vehicle at the point.

8. A system comprising:
the task management device according to claim 5; and
the terminal device.

9. The task management device according to claim 1, further comprising a communication unit configured to perform communication with the vehicle, wherein:
the vehicle is configured to automatically perform the maintenance; and
the control unit is configured to perform the maintenance start control by transmitting data instructing the vehicle to start the maintenance to the vehicle via the communication unit.

10. A system comprising:
the task management device according to claim 9; and
the vehicle.

11. The task management device according to claim 1, further comprising a communication unit configured to perform communication with a terminal device of a worker who changes an interior or an exterior of the vehicle, wherein the control unit is configured to execute the mode switching control by transmitting data instructing the worker to change the interior or the exterior of the vehicle to the interior or the exterior corresponding to the second mode to the terminal device via the communication unit.

12. The task management device according to claim 1, further comprising a communication unit configured to perform communication with the vehicle, wherein:
the vehicle automatically changes an interior or an exterior of the vehicle; and
the control unit is configured to execute the mode switching control by transmitting, to the vehicle via the communication unit, data instructing the vehicle to change the interior or the exterior of the vehicle to the interior or the exterior corresponding to the second mode.

13. The task management device according to claim 1, wherein the control unit is configured to determine a start time of the maintenance during the period by referring to data indicating a start time of a period in which the vehicle is operated in the second mode and data indicating a required time of the maintenance.

14. The task management device according to claim 1, wherein:
an application corresponding to the first mode is sales of a product or delivery of an article; and
an application corresponding to the second mode is transportation of a passenger.

15. The task management device according to claim 1, wherein the maintenance includes cleaning.

16. The task management device according to claim 1, wherein the maintenance includes odor removal or sterilization.

17. The task management device according to claim 1, wherein the maintenance includes temperature adjustment.

18. A vehicle comprising the task management device according to claim 1.

19. A task management method comprising:
executing maintenance start control for starting maintenance of an internal environment of a vehicle by a control unit during a period in which the vehicle operated in a mode corresponding to an application is operated in a first mode; and
executing mode switching control for switching the vehicle to a second mode different from the first mode by the control unit after the maintenance is completed.

20. The task management method according to claim 19, further comprising instructing a robot that performs the maintenance to get into the vehicle during the period.
